(19) United States
(12) Patent Application Publication
(10) Pub. No.: US 2014/0253595 A1
(43) Pub. Date: Sep. 11, 2014

(54) METHOD FOR DISPLAYING OBJECT AND ELECTRONIC DEVICE THEREOF

(71) Applicant: Samsung Electronics Co., Ltd., Gyeonggi-do (KR)

(72) Inventor: Ji-Woo Lee, Gyeongsangbuk-do (KR)

(73) Assignee: Samsung Electronics Co., Ltd., Gyeonggi-do (KR)

(21) Appl. No.: 14/203,267

(22) Filed: Mar. 10, 2014

(30) Foreign Application Priority Data
Mar. 8, 2013 (KR) 10-2013-0025121

(51) Int. Cl. G06T 11/60; G06F 3/041

(52) U.S. Cl. CPC G06T 11/60; G06F 3/041
USPC 345/647; 345/173

(57) ABSTRACT

A method and device for controlling a display of an object in an electronic device include displaying a plurality of objects; detecting input of a touch pattern for changing a shape or location of at least one of the plurality of objects; and changing the shape or location of the at least one object considering the pattern and displaying the object.

### PRIORITY

The present application is related and claims priority under 35 U.S.C. §119 to an application filed in the Korean Intellectual Property Office on Mar. 8, 2013 and assigned Serial No. 10-2013-0025121, the contents of which are incorporated herein by reference.

### TECHNICAL FIELD

Example embodiments of the present disclosure relate to methods for controlling a display of an object and an electronic device thereof.

### BACKGROUND

Electronic devices which have become necessities for modern people due to portability are developing into multimedia devices that provide a variety of services such as a voice and video communication function, an information input and output function, and data exchange.

When the electronic device is equipped with a touch screen, the electronic device displays writing which is input through the touch screen on the touch screen. In this embodiment, the electronic device may provide an editing mode for the writing input to the touch screen. For example, the electronic device may provide the editing mode to apply deletion, addition, selection of the input writing, and at least one effect on the writing.

### SUMMARY

To address the above-discussed deficiencies, it is a primary object to provide methods for controlling a display of an object and an electronic device thereof. As described above, the user of the electronic device inputs writing through the touch screen and edits the input writing. However, the user of the electronic device cannot edit the input writing freely and can use only an editing effect that is configured by a manufacturer of an application program.

An aspect of the present disclosure is to solve at least the above-mentioned problems and/or disadvantages and to provide at least the advantages described below. Accordingly, an aspect of the present disclosure is to provide a method and device for controlling an object in an electronic device.

Another aspect of the present disclosure is to provide a method and device for controlling a display of an object in an electronic device.

Another aspect of the present disclosure is to provide a method and device for controlling a display of an object considering a shape of an input touch pattern in an electronic device.

Another aspect of the present disclosure is to provide a method and device for changing display coordinates of an object considering a shape of an input touch pattern in an electronic device.

Another aspect of the present disclosure is to provide a method and device for changing a display size of an object considering a shape of an input touch pattern in an electronic device.

Another aspect of the present disclosure is to provide a method and device for changing a display angle of an object considering a shape of an input touch pattern in an electronic device.

According to an aspect of the present disclosure, a method for displaying an object in an electronic device includes: displaying a plurality of objects; detecting input of a touch pattern for changing a shape or location of at least one of the plurality of objects; and changing the shape or location of the at least one object considering the pattern and displaying the object.

According to another aspect of the present disclosure, an device includes: at least one processor; at least one memory; and at least one processor for displaying a plurality of objects, detecting input of a pattern for changing a shape or location of at least one of the plurality of objects, and controlling to change the shape or location of the at least one object considering the pattern and display the object.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a view of a block configuration of an electronic device according to various example embodiments of the present disclosure;

FIG. 2 illustrates a view of a detailed block configuration of a processor according to various example embodiments of the present disclosure;

FIG. 3A illustrates a view of a process for displaying an object considering an input touch pattern in an electronic device according to various example embodiments of the present disclosure;

FIG. 3B illustrates a view of a configuration of an electronic device for displaying an object considering an input touch pattern according to various example embodiments of the present disclosure;

FIG. 4 illustrates a process for controlling a display location of a letter considering an input touch pattern in an electronic device according to various example embodiments of the present disclosure;

FIG. 5 illustrates a process for controlling a size of a letter considering an input touch pattern in an electronic device according to various example embodiments of the present disclosure;

FIG. 6 illustrates a process for controlling an angle of a letter considering an input touch pattern in an electronic device according to various example embodiments of the present disclosure; and

FIGS. 7A to 7H illustrate views of screen configurations for controlling a display of letters considering an input touch pattern in an electronic device according to various example embodiments of the present disclosure.

### DETAILED DESCRIPTION

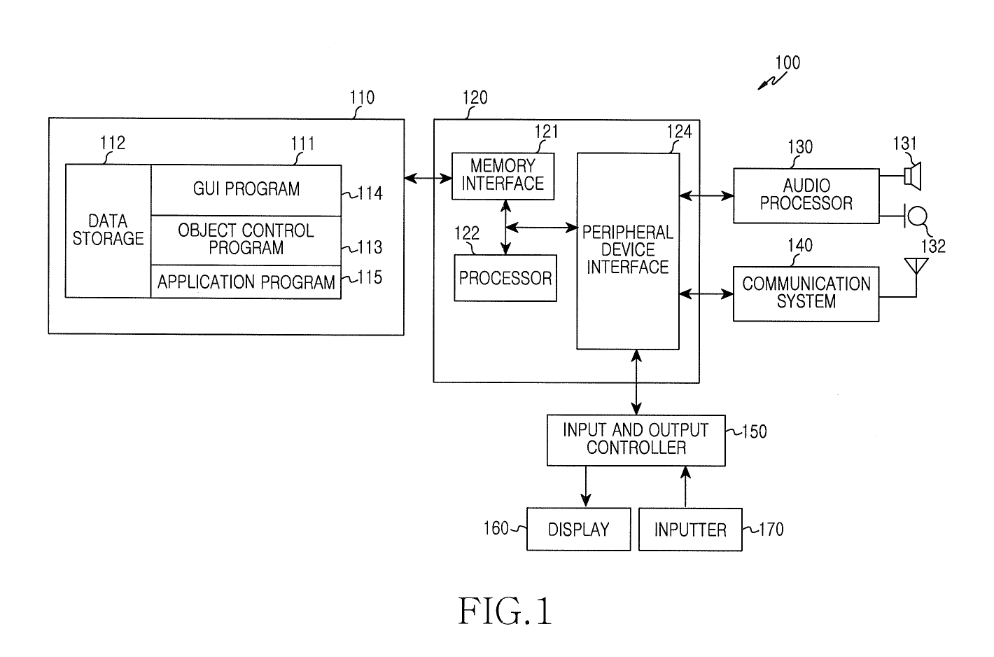

FIGS. 1 through 7H, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system and method. Example embodiments of the present disclosure will be described herein below with reference to the accompanying drawings. In the following description, detailed descriptions of well-known functions or configurations will be omitted since they would unnecessarily obscure the subject matters of the present disclosure. Also, the terms used herein are defined according to the functions of the present disclosure. Thus, the terms may vary depending on users' or operators' intentions or practices. Therefore, the terms used herein should be understood based on the descriptions made herein.

Hereinafter, a technique for controlling a display of an object considering a shape of an input touch pattern in an electronic device according to various example embodiments of the present disclosure will be explained. The object recited herein may include at least one of at least one letter which is input by writing, at least one letter which is input through a keypad, an icon, a picture, a photo, a figure, and a clip art.

Hereinafter, the electronic device may include a mobile communication terminal, a Personal Digital Assistant (PDA), a Personal Computer (PC), a laptop computer, a smart phone, a net book, a television, a Mobile Internet Device (MID), a Ultra Mobile PC (UMPC), a tablet PC, a navigation device, a smart TV, a digital camera, a digital watch, a refrigerator, an MP3 player, and the like, which are equipped with a touch screen.

FIG. 1 illustrates a block configuration of an electronic device according to various example embodiments of the present disclosure.

As shown in FIG. 1, an electronic device 100 may include a memory 110, a processor unit 120, an audio processor 130, a communication system 140, an input and output controller 150, a display 160, and an inputter 160. Herein, a plurality of memories 110 may be provided.

A detailed explanation of each element is as follows.

The memory 110 may include program storage 111 to store a program for controlling an operation of the electronic device 100, and data storage 112 to store data that is generated while the program is executed. For example, the data storage 112 stores at least one object to be displayed on the display 160. The object recited herein may include at least one of at least one letter which is input by writing, at least one letter which is input through a keypad, an icon, a picture, a photo, a figure, and a clip art.

The program storage 111 may include a Graphic User Interface (GUI) program 114, an object control program 113, and at least one application program 115. The program included in the program storage 111 is a set of instructions and may be referred to as an instruction set.

The GUI program 114 may include at least one software element for providing a user interface on the display 160 using graphics. For example, the GUI program 114 may include an instruction to display information on an application program driven by a processor 122 on the display 160. For another example, the GUI program 114 may include an instruction to display at least one object on the display 160 by means of the processor 122. For another example, the GUI program 114 may include an instruction to display at least one pattern on the display 160 by means of the processor 122.

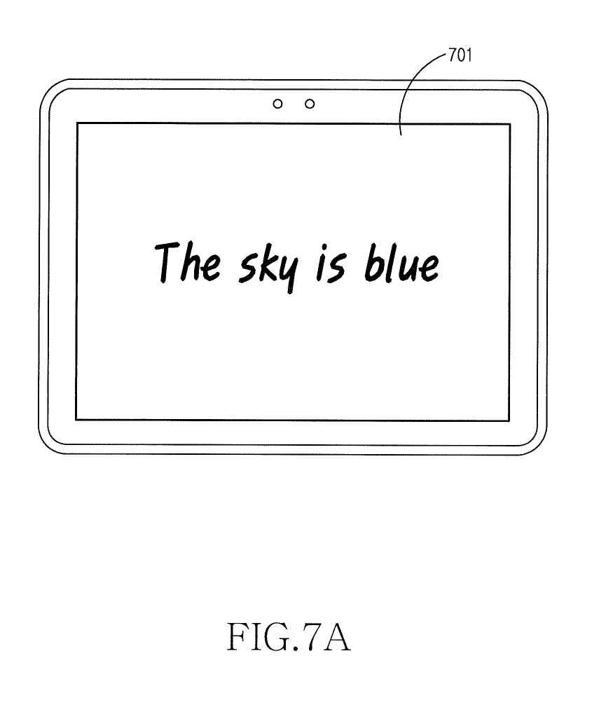

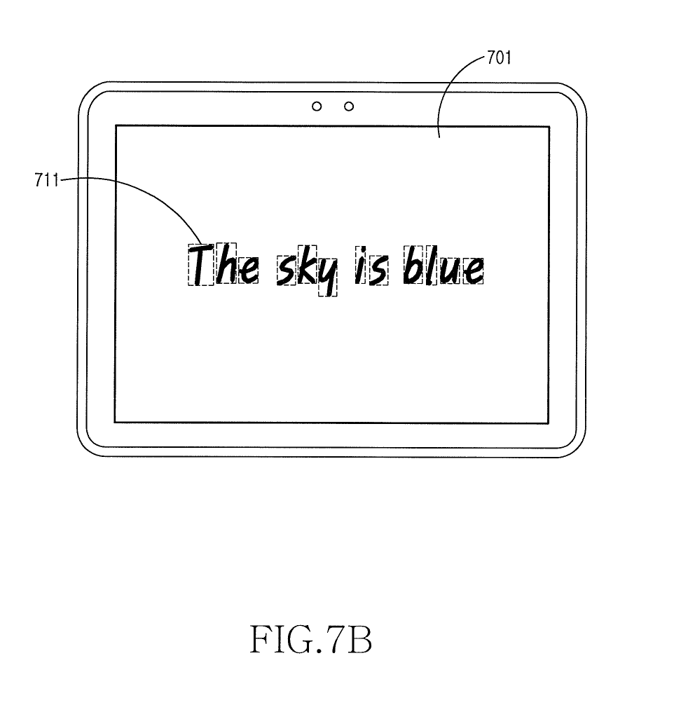

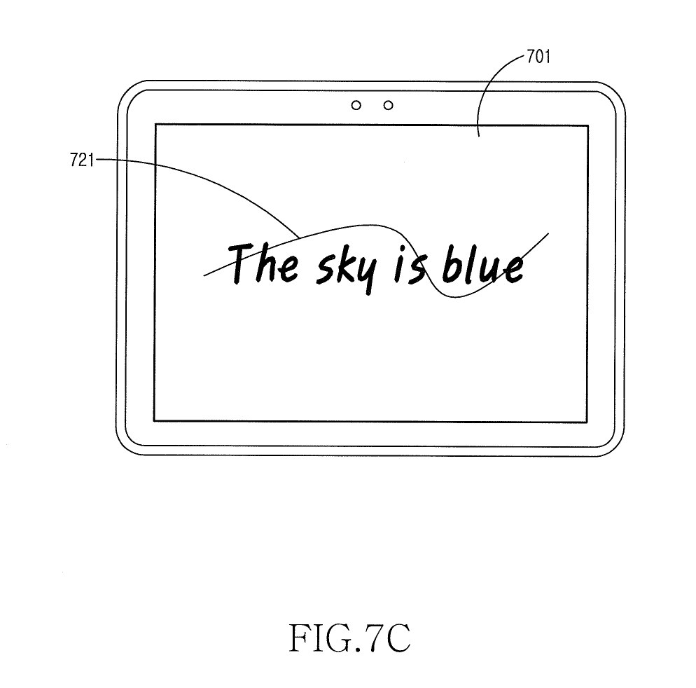

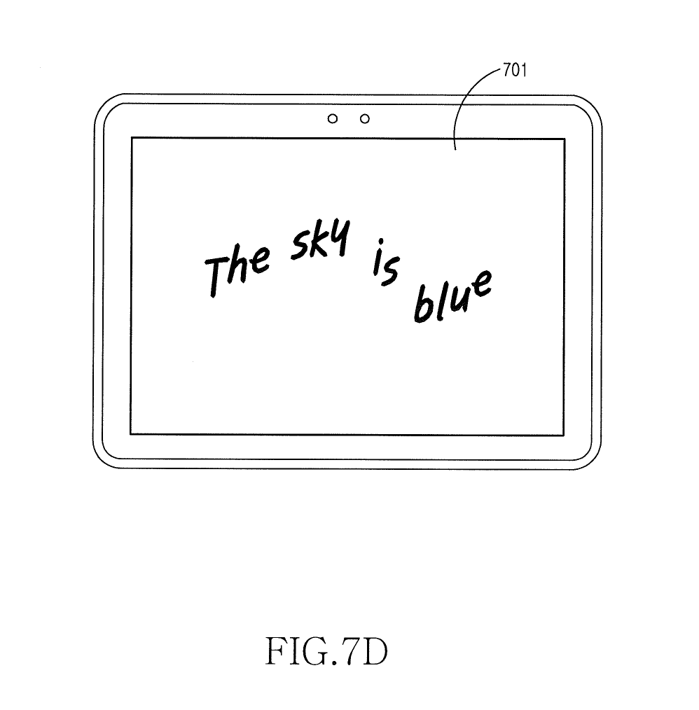

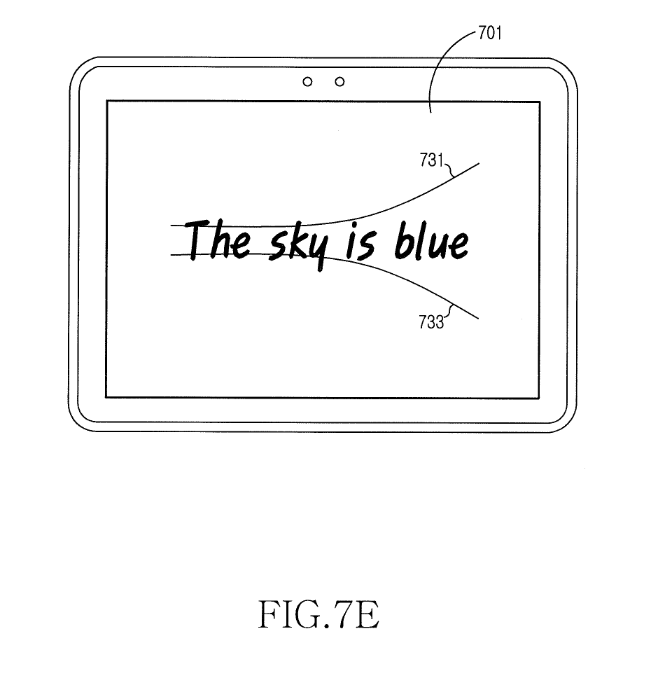

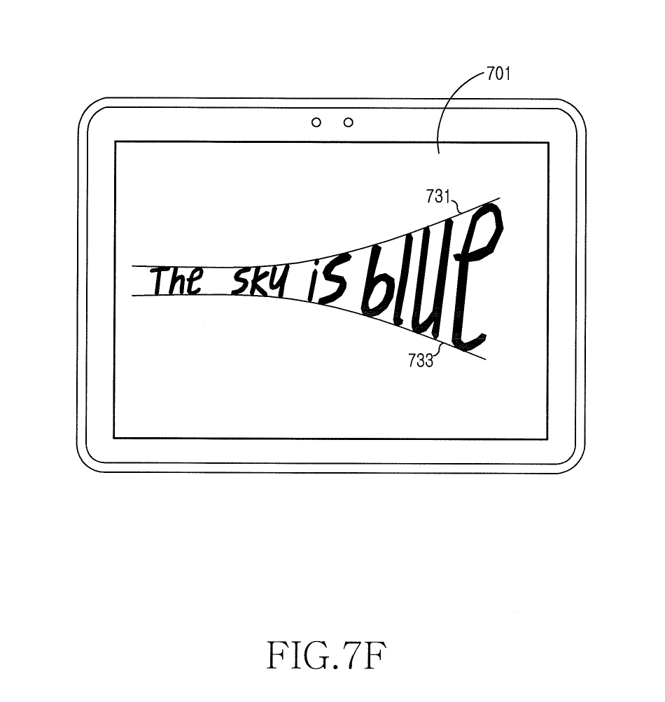

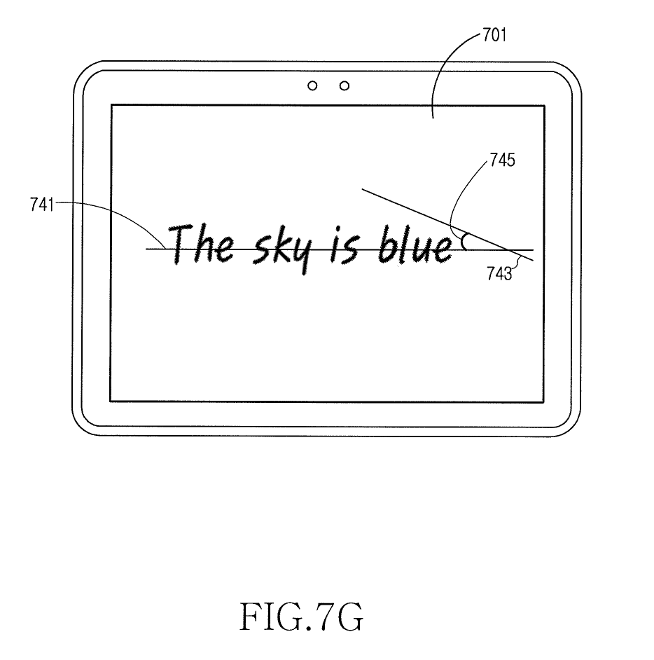

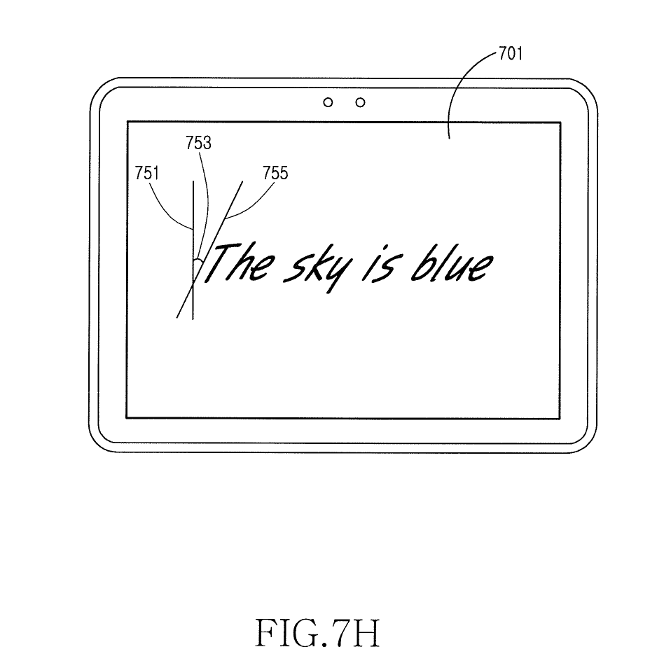

The object control program 113 may include at least one software element for controlling an object considering a shape of an input touch pattern. For example, when “The sky is blue” is input by writing through a touch screen 701 as shown in FIG. 7A, the object control program 113 controls to rearrange “The sky is blue” considering a shape of an input touch pattern and display the same as shown in FIG. 7D. For another example, when a first pattern 731 and a second pattern 733 are input as shown in FIG. 7E, the object control program 113 may control to magnify or reduce “The sky is blue” considering the first pattern 731 and the second pattern 733 and display the same as shown in FIG. 7F. For another example, when a third pattern 741 and a fourth pattern 743 are input as shown in FIG. 7G, the object control program 113 may control to rearrange “The sky is blue” considering the third pattern 741, change an angle formed by an area including each letter of “The sky is blue” and an imaginary vertical line, considering an angle 745 formed by the third pattern 741 and the fourth pattern 743, and display the object, as shown in FIG. 7F.

In addition, the object control program 113 may determine an area for at least one object. For example, when “The sky is blue” is input by writing through the touch screen 701 as shown in FIG. 7A, the object control program 113 determines areas 711 including respective letters as shown in FIG. 7B. For example, the object control program 113 may determine rectangular areas including the respective letters. In this embodiment, the object control program 113 determines central points of the rectangular areas including the respective letters.

In addition, the object control program 113 may detect input of at least one pattern. For example, the object control program 113 checks whether a touch pattern forming a single imaginary line having a single start point and a single end point is input or not. When a plurality of overlapping x-axis coordinates exit from among x-axis coordinates of the pattern, the object control program 113 may reconfigure the pattern by excluding a y-axis range including the plurality of overlapping x-axis coordinates. For another example, the object control program 113 may check whether two patterns that each have a single start point and a single end point and do not intersect are input or not. For another example, the object control program 113 may check whether two patterns that each have a single start point and a single end point and intersect at a single point are input or not.

The application program 115 may include a software element for at least one application program installed in the electronic device 100.

The processor unit 120 may include a memory interface 121, at least one processor 122, and a peripheral device interface 124. The memory interface 121, the at least one processor 122, and the peripheral device interface 124 included in the processor unit 120 may be integrated into at least one integrated circuit or may be implemented as separate elements.

The memory interface 121 controls access of the elements like the processor 122 or the peripheral device interface 124 to the memory 110.

The peripheral device interface 124 controls connection of the input and output controller 150 of the electronic device 100 with the processor 122 and the memory interface 121.

The processor 120 controls the electronic device 100 to provide a variety of services using at least one software program. In this embodiment, the processor 122 executes at least one program stored in the memory 110 and provides a service corresponding to the program.

The audio processor 130 provides an audio interface between the user and the electronic device 100 through a speaker 131 and a microphone 132.

The communication system 140 performs a communication function for voice communication and data communication. In this embodiment, the communication system 140 may be divided into a plurality of communication sub-modules for supporting different communication networks. For example, although not limited thereto, the communication network may include a Global System for Mobile communications (GSM) network, an Enhanced Data rates for GSM Evolution (EDGE) network, a Code Division Multiple Access (CDMA) network, a Wideband-CDMA (W-CDMA) network, a Long Term Evolution (LIE) network, an Orthogonal Frequency-Division Multiplexing Access (OFDMA) network, a wireless Local Area Network (LAN), a Bluetooth network, Near Field Communication (NFC), and the like.

The input and output controller 150 provides an interface between an input and output device like the display 160 and the inputter 170 and the peripheral device interface 124.

The display 160 displays state information of the electronic device 100, a text which is input by the user, a moving image and a still image, and the like. For example, the display 160 displays information on an application program which is driven by the processor 122 under the control of the GUI program 114. For another example, the display 160 may display at least one object under the control of the GUI program 114. For another example, the display 160 may display at least one pattern under the control of the GUI program 114.

The inputter 170 provides input data which is generated by user's selection to the processor unit 120 through the input and output controller 150. In this embodiment, the inputter 170 may include a keypad including at least one hardware button and a touch screen to detect touch information. For example, the inputter 170 provides touch information such as a touch, a touch movement, touch release, and the like, which is detected through the touch screen, to the processor 122 through the input and output controller 150.

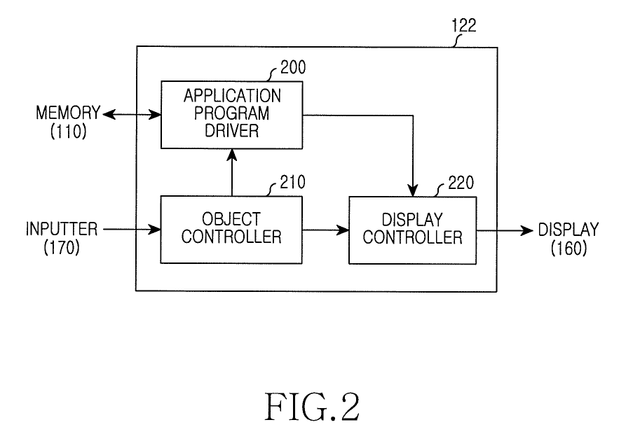

FIG. 2 illustrates a detailed block configuration of a processor according to various example embodiments of the present disclosure.

As shown in FIG. 2, the processor 122 may include an application program driver 200, an object controller 210, and a display controller 220.

The application program driver 200 executes the at least one application program 115 stored in the program storage 111 and provides a service corresponding to the application program. In this embodiment, the application program driver 200 may receive at least one of an arrangement value, a size value, and an angle value of an object from the object controller 210.

The object controller 210 executes the object control program 113 stored in the program storage 111 and controls an object considering a shape of an input touch pattern. For example, when “The sky is blue” is input by writing through the touch screen 701 as shown in FIG. 7A, the object controller 210 controls the display controller 220 to rearrange “The sky is blue” considering the shape of the input touch pattern and display the same as shown in FIG. 7D. For another example, when the first pattern 731 and the second pattern 733 are input as shown in FIG. 7E, the object controller 210 controls the display controller 220 to magnify or reduce “The sky is blue” considering the first pattern 731 and the second pattern 733 and display the same as shown in FIG. 7F. For another example, when the third pattern 741 and the fourth pattern 743 are input as shown in FIG. 7G, the object controller 210 controls the display controller 220 to rearrange “The sky is blue” considering the third pattern 741, change the angle formed by the area including each letter included in “The sky is blue” and the imaginary vertical line, considering the angle 745 formed by the third pattern 741 and the fourth pattern 743, and display the object as shown in FIG. 7H.

In addition, the object controller 210 may determine an area for at least one object. For example, when “The sky is blue” is input by writing through the touch screen 701 as shown in FIG. 7A, the object controller 210 determines areas 711 including respective letters as shown in FIG. 7B. For example, the object controller 210 determines rectangular areas including the respective letters. In this embodiment, the object controller 210 determines central points of the rectangular areas including the respective letters.

In addition, the object controller 210 may detect input of at least one pattern. For example, the object controller 210 checks whether a single line having a single start point and a single end point is input or not. When a plurality of overlapping x-axis coordinates exist from among x-axis coordinates of the pattern, the object controller 210 may reconfigure the pattern by excluding a y-axis range including the plurality of overlapping x-axis coordinates. For another example, the object controller 210 may check whether two patterns that each have a single start point and a single end point and do not intersect are input or not. For another example, the object controller 210 may check whether two patterns that each have a single start point and a single end point and intersect at a single point are input or not.

The display controller 220 executes the GUI program 114 stored in the program storage 111 and controls to display a user interface on the display 160 using graphics. For example, the display controller 220 controls to display information on an application program which is driven by the processor 122 on the display 160. For another example, the display controller 220 may be controlled by the object controller 210 to display at least one object on the display 160. For another example, the display controller 220 may be controlled by the object controller 210 to display at least one pattern on the display 160.

In the above-described example embodiment, the electronic device 100 controls the object considering the shape of the input touch pattern using the processor 122 including the object controller 210.

According to another example embodiment, the electronic device 100 may include a separate object control module to control an object considering a shape of an input touch pattern.

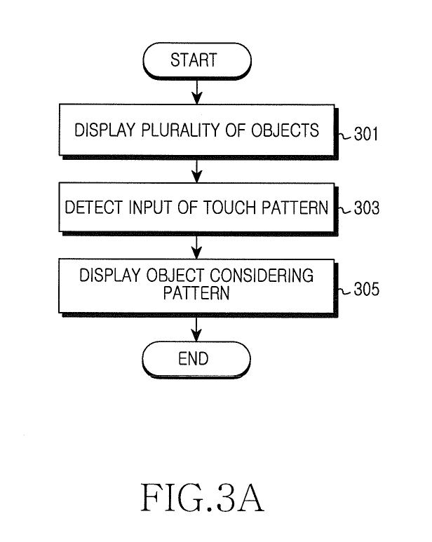

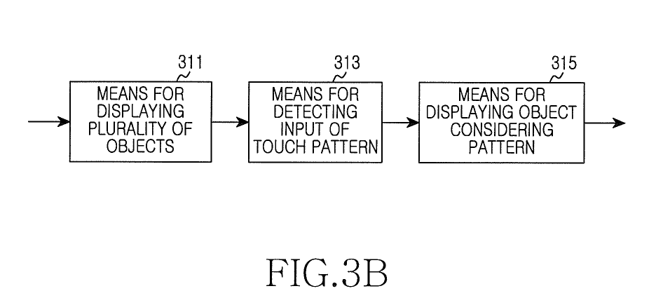

FIG. 3A illustrates a process for displaying an object considering an input touch pattern in an electronic device according to various example embodiments of the present disclosure.

Referring to FIG. 3A, the electronic device displays a plurality of objects in operation 301. The object recited herein may include at least one of at least one letter which is input by writing, at least one letter which is input through a keypad, an icon, a picture, a photo, a figure, and a clip art. For example, when “The sky is blue” is input by writing through the touch screen 701 as shown in FIG. 7A, the electronic device determines areas 711 including respective letters as shown in FIG. 7B. For example, the electronic device determines rectangular areas including the respective letters. In this embodiment, the electronic device determines central points of the rectangular areas including the respective letters.

After displaying the plurality of objects, the electronic device proceeds to operation 303 to detect input of a touch pattern. For example, the electronic device checks whether a single line having a single start point and a single end point is input or not. When a plurality of overlapping x-axis coordinates exist from among x-axis coordinates, the electronic device may reconfigure the pattern by excluding a y-axis range including the plurality of overlapping x-axis coordinates. For another example, the electronic device may check whether two patterns that each have a single start point and a single end point and do not intersect are input or not. For another example, the electronic device may check whether two patterns that each have a single start point and a single end point and intersect at a single point are input or not.

After inputting the touch pattern, the electronic device proceeds to operation 305 to display the plurality of objects which are displayed in operation 301 considering the shape of the pattern which is input in operation 303. For example, when a pattern 721 is input as shown in FIG. 7C, the electronic device rearranges “The sky is blue” considering the shape of the pattern and displays the same as shown in FIG. 7D. In this embodiment, the electronic device rearranges the letters in a vertical direction such that the central point of the area including each letter, which is determined in operation 301, overlaps the pattern. For another example, when the first pattern 731 and the second pattern 733 are input as shown in FIG. 7E, the electronic device may magnify or reduce “The sky is blue” considering the first pattern 731 and the second pattern 733 and display the same as shown in FIG. 7F. In this embodiment, the electronic device magnifies or reduces the letters in the vertical direction such that the outside of the area including each letter, which is determined in operation 301, overlaps the pattern. For another example, when the third pattern 741 and the fourth pattern 743 are input as shown in FIG. 7G, the electronic device may rearrange “The sky is blue” considering the third pattern 741, change the angle of each letter included in “The sky is blue” considering the angle 745 formed by the third pattern 741 and the fourth pattern 743, and display the object, as shown in FIG. 7H. In this embodiment, as shown in FIGS. 7G and 7H, the electronic device changes an angle 753 formed by the area including each letter and an imaginary vertical line 751, considering the angle 745 formed by the horizontal line segment of the areas including the respective letters determined in operation 301 and the fourth pattern 743. The angle 745 formed by the horizontal line segment of the areas including the respective letters and the fourth pattern 743 is equal to the angle 753 formed by the area including each letter and the imaginary vertical line 751.

Thereafter, the electronic device finishes the present algorithm.

As described above, each process for displaying the object in the electronic device may be configured as a means for displaying the object as shown in FIG. 3B.

FIG. 3B illustrates a configuration of an electronic device for displaying an object considering an input touch pattern according to various example embodiments of the present disclosure.

Referring to FIG. 3B, the electronic device may include a first means 311 for displaying a plurality of objects, a second means 313 for detecting input of a touch pattern, and a third means 315 for displaying the object considering the pattern.

The first means 311 displays a plurality of objects. The object recited herein may include at least one of at least one letter which is input by writing, at least one letter which is input through a keypad, an icon, a picture, a photo, a figure, and a clip art. For example, when “The sky is blue” is input by writing through the touch screen 701 as shown in FIG. 7A, the electronic device determines areas 711 including respective letters as shown in FIG. 7B. For example, the electronic device determines rectangular areas including the respective letters. In this embodiment, the electronic device determines central points of the rectangular areas including the respective letters.

The second means 313 detects input of a touch pattern. For example, the electronic device checks whether a single line having a single start point and a single end point is input or not. When a plurality of overlapping x-axis coordinates exist from among x-axis coordinates of the pattern, the electronic device may reconfigure the pattern by excluding a y-axis range including the plurality of overlapping x-axis coordinates. For another example, the electronic device may check whether two patterns that each have a single start point and a single end point and do not intersect are input or not. For another example, the electronic device may check whether two patterns that each have a single start point and a single end point and intersect at a single point are input or not.

The third means 315 displays the plurality of objects considering the shape of the pattern. For example, when the pattern 721 is input as shown in FIG. 7C, the electronic device rearranges “The sky is blue” considering the shape of the pattern and displays the same as shown in FIG. 7D. In this embodiment, the electronic device rearranges the letters in the vertical direction such that the central point of the area including each letter, which is determined in operation 301, overlaps the pattern. For another example, when the first pattern 731 and the second pattern 733 are input as shown in FIG. 7E, the electronic device may magnify or reduce “The sky is blue” considering the first pattern 731 and the second pattern 733 and display the same as shown in FIG. 7F. In this embodiment, the electronic device magnifies or reduces the letters in the vertical direction such that the outside of the area including each letter, which is determined in operation 301, overlaps the pattern, and display the same. For another example, when the third pattern 741 and the fourth pattern 743 are input as shown in FIG. 7G, the electronic device may rearrange “The sky is blue” considering the third pattern 741, change the angle of each letter included in “The sky is blue” considering the angle 745 formed by the third pattern 741 and the fourth pattern 743, and display the object, as shown in FIG. 7H. In this embodiment, as shown in FIGS. 7G and 7H, the electronic device changes the angle 753 formed by the area including each letter and the imaginary vertical line 751, considering the angle 745 formed by the horizontal line segment of the areas including the respective letters determined in operation 301 and the fourth pattern 743. The angle 745 formed by the horizontal line segment of the areas including the respective letters and the fourth pattern 743 is equal to the angle 753 formed by the area including each letter and the imaginary vertical line 751.

As described above, the electronic device may include the means for displaying the object. In this embodiment, the respective means for displaying the object in the electronic device may be configured as a single means.

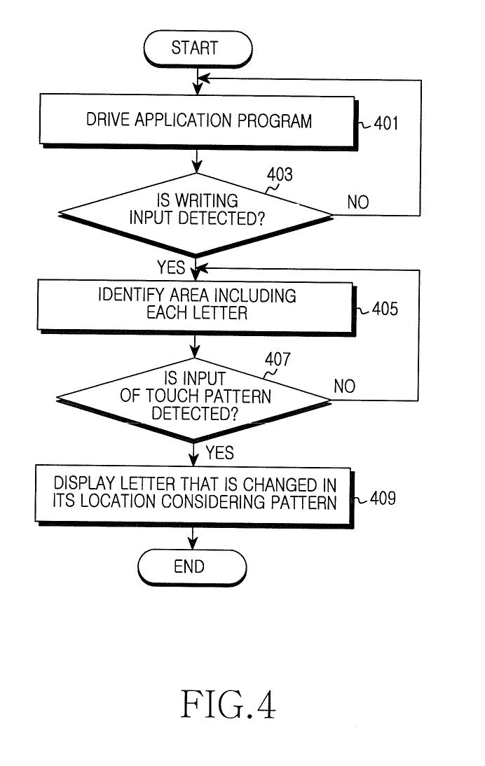

FIG. 4 illustrates a process for controlling a display location of a letter considering an input touch pattern in an electronic device according to various example embodiments of the present disclosure.

Referring to FIG. 4, the electronic device drives an application program in operation 401. The application program recited herein may include at least one application program for displaying writing which is input by a user on a screen. For example, the application program may be at least one of a memo program, an image editing program, and a viewer program.

After driving the application program, the electronic device proceeds to operation S403 to check whether writing input is detected or not. When the writing input is not detected, the electronic device resumes operation 401 to maintain the driving state of the application program.

When the writing input is detected, the electronic device proceeds to operation 405 to identify an area including each letter. For example, when “The sky is blue” is input through the touch screen 701 as shown in FIG. 7A, the electronic device determines areas 711 including respective letters as shown in FIG. 7B. For example, the electronic device determines rectangular areas including the respective letters. In this embodiment, the electronic device determines central points of the rectangular areas including the respective letters.

After identifying the area including each letter, the electronic device proceeds to operation 407 to check whether input of a touch pattern is detected or not. The pattern recited herein may include a single line that has a single start point and a single end point. When a plurality of overlapping x-axis coordinates exist from among x-axis coordinates of the pattern, the electronic device may reconfigure the pattern by excluding the plurality of overlapping x-axis coordinates. When the input of the touch pattern is not detected, the electronic device resumes operation 405 to identify the area including each letter.

Alternatively, when the input of touch pattern is detected, the electronic device proceeds to operation 409 to display the letter that is changed in its location considering the pattern. For example, when the pattern 721 is input as shown in FIG. 7C, the electronic device rearranges “The sky is blue” considering the shape of the pattern and displays the same as shown in FIG. 7D. For example, the electronic device rearranges the letters in the vertical direction such that the central point of the area including each letter, which is determined in operation 405, overlaps the pattern.

In addition, when writing input is detected, the electronic device may recognize each of the written letters. In this embodiment, the electronic device may change the shape of the written letter using at least one font and display the letter.

Thereafter, the electronic device finishes the present algorithm.

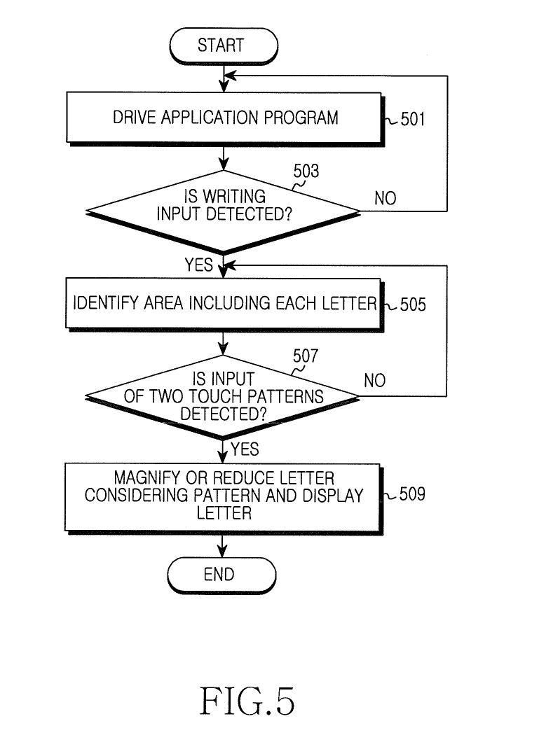

FIG. 5 illustrates a process for controlling a size of a letter considering an input touch pattern in an electronic device according to various example embodiments of the present disclosure.

Referring to FIG. 5, the electronic device drives an application program in operation 501. The application program recited herein may include at least one application program for displaying writing which is input by a user on a screen. For example, the application program may be at least one of a memo program, an image editing program, and a viewer program.

After driving the application, the electronic device proceeds to operation 503 to check whether writing input is detected or not. When the writing input is not detected, the electronic device resumes operation 501 to maintain the driving state of the application program.

Alternatively, when the writing input is detected, the electronic device proceeds to operation 505 to identify an area including each letter. For example, when “The sky is blue” is input through the touch screen 701 as shown in FIG. 7A, the electronic device determines areas 711 including respective letters as shown in FIG. 7B. For example, the electronic device determines rectangular areas including the respective letters.

After identifying the area including each letter, the electronic device proceeds to operation 507 to check whether input of two touch patterns is detected or not. The two patterns recited herein may include two patterns that each have a single start point and a single end point and do not intersect. When the input of the two touch patterns is not detected, the electronic device resumes operation 505 to identify the area including each letter.

Alternatively, when the input of the two touch patterns is detected, the electronic device proceeds to operation 509 to magnify or reduce the letters considering the patterns and display the same. For example, when the first pattern 731 and the second pattern 733 are input as shown in FIG. 7E, the electronic device magnifies or reduces “The sky is blue” considering the first pattern 731 and the second pattern 733 and displays the same as shown in FIG. 7F. For example, the electronic device may magnify or reduce the letters such that the outside of the rectangular area of each letter, which is determined in operation 505, overlaps the patterns.

In addition, when writing input is detected, the electronic device may recognize each of the written letters. In this embodiment, the electronic device may change the shape of the written letter using at least one font and display the letter.

Thereafter, the electronic device finishes the present algorithm.

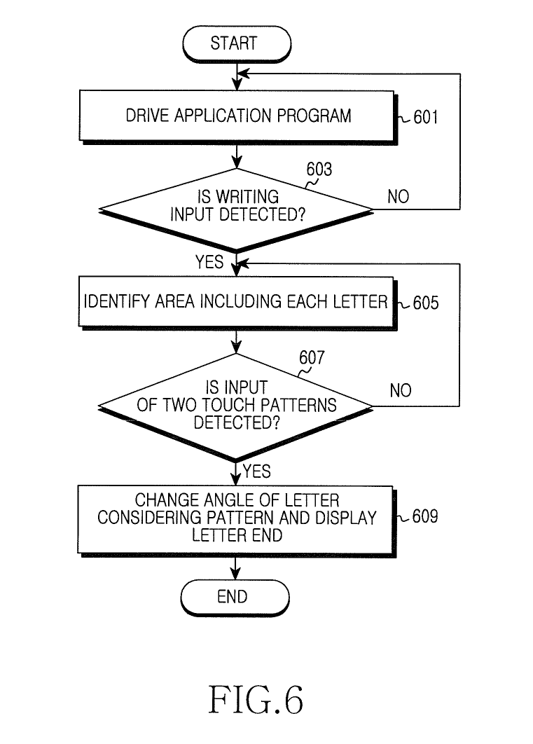

FIG. 6 illustrates a process for controlling an angle of a letter considering an input touch pattern in an electronic device according to various example embodiments of the present disclosure.

Referring to FIG. 6, the electronic device drives an application program in operation 601. The application program recited herein may include at least one application program for displaying writing which is input by a user on a screen. For example, the application program may be at least one of a memo program, an image editing program, and a viewer program.

After driving the application program, the electronic device proceeds to operation 603 to check whether writing input is detected or not. When the writing input is not detected, the electronic device resumes operation 601 to maintain the driving state of the application program.

Alternatively, when the writing input is detected, the electronic device proceeds to operation 605 to identify an area including each letter. For example, when “The sky is blue” is input through the touch screen 701 as shown in FIG. 7A, the electronic device determines areas 711 including respective letters as shown in FIG. 7B. For example, the electronic device determines rectangular areas including the respective letters.

After identifying the area including each letter, the electronic device proceeds to operation 607 to check whether input of two touch patterns is detected or not. The two patterns recited herein may include two patterns that each have a single start point and a single end point and intersect at a single point. When the input of the two touch patterns is not detected, the electronic device resumes operation 605 to identify the area including each letter.

Alternatively, when the input of the two touch patterns is detected, the electronic device proceeds to operation 609 to change an angle of the letter considering the pattern and display the letter. For example, when the third pattern 741 and the fourth pattern 743 are input as shown in FIG. 7G, the electronic device rearranges “The sky is blue” considering the third pattern 741, changes the angle of each letter included in “The sky is blue” considering the angle 745 formed by the third pattern 741 and the fourth pattern 743, and displays the letters, as shown in FIG. 7H. For example, as shown in FIGS. 7G and 7H, the electronic device changes the angle 753 formed by the area including each letter and the imaginary vertical line 751, considering the angle 745 formed by the horizontal line segment of the areas including the respective letters determined in operation 605 and the fourth pattern 743. The angle 745 formed by the horizontal line segment of the areas including the respective letters and the fourth pattern 743 is equal to the angle 753 formed by the area including each letter and the imaginary vertical line 751.

In addition, when writing input is detected, the electronic device may recognize each of the written letters. In this embodiment, the electronic device may change the shape of the written letter using at least one font and display the letter.

Thereafter, the electronic device finishes the present algorithm.

As described above, the electronic device according the various example embodiments of the present disclosure controls the display of the object considering the shape of the input touch pattern, such that the user of the electronic device can display the object in a desired location in a desired shape.

It will be appreciated that embodiments of the present disclosure according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure.

Accordingly, embodiments provide a program comprising code for implementing device or a method as claimed in any one of the claims of this specification and a machine-readable storage storing such a program. Still further, such programs may be conveyed electronically via any medium such as a communication signal carried over a wired or wireless connection and embodiments suitably encompass the same.

While the disclosure has been shown and described with reference to certain embodiments thereof, it will be understood by those skilled in the art that various changes in form and details may be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

What is claimed is:

1. A method in an electronic device, the method comprising:
displaying a plurality of objects;
detecting input of a touch pattern for changing a shape or location of at least one of the plurality of objects; and
changing the shape or location of the at least one object considering the pattern and displaying the object.

2. The method of claim 1, wherein the object comprises at least one of at least one letter which is input by writing, at least one letter which is input through a keypad, an icon, a picture, a photo, a figure, and a clip art.

3. The method of claim 1, wherein the pattern comprises at least one line comprising a single start point and a single end point, and, when a plurality of overlapping x-axis coordinates exist from among x-axis coordinates of the pattern, an y-axis area comprising the plurality of overlapping x-axis coordinates is excluded from the pattern.

4. The method of claim 1, wherein the displaying the plurality of objects comprises:
determining an area for each of the plurality of objects; and
determining a central point of the area.

5. The method of claim 1, wherein the changing the shape or location of the at least one object and displaying the object comprises changing coordinates of the at least one object considering the pattern and displaying the object.

6. The method of claim 1, wherein the changing the shape or location of the at least one object and displaying the object comprises changing a size of the at least one object considering the pattern and displaying the object.

7. The method of claim 6, wherein the changing the size of the at least one object and displaying the object comprises, when two patterns are input, changing the size of the at least one object considering a distance between the two patterns and displaying the object.

8. The method of claim 1, wherein the changing the shape or location of the at least one object and displaying the object comprises changing an angle of the at least one object considering the pattern and displaying the object.

9. The method of claim 8, wherein the changing the size of the at least one object and displaying the object comprises:
when two patterns are input, changing coordinates of the at least one object considering a first pattern; and
changing an angle of the at least one object considering an angle between the first pattern and a second pattern and displaying the object.

10. An electronic device comprising:
at least one processor;
at least one memory; and
at least one processor configured to control a display to display a plurality of objects, detect input of a pattern for changing a shape or location of at least one of the plurality of objects, and control to change the shape or location of the at least one object considering the pattern and control the display to display the object.

11. The device of claim 10, wherein the object comprises at least one of at least one letter which is input by writing, at least one letter which is input through a keypad, an icon, a picture, a photo, a figure, and a clip art.

12. The device of claim 10, wherein the pattern comprises at least one line comprising a single start point and a single end point, and, when a plurality of overlapping x-axis coordinates exist from among x-axis coordinates of the pattern, a y-axis area comprising the plurality of x-axis coordinates is excluded from the pattern.

13. The device of claim 10, wherein the processor is configured to determine an area for each of the plurality of objects, and determine a central point of the area.

14. The device of claim 10, wherein the processor is configured to control to change coordinates of the at least one object considering the pattern and control the display to display the object.

15. The device of claim 10, wherein the processor is configured to control to change a size of the at least one object considering the pattern and control the display to display the object.

16. The device of claim 15, wherein, when two patterns are input, the processor is configured to control to change the size of the at least one object considering a distance between the two patterns and control the display to display the object.

17. The device of claim 10, wherein the processor is configured to control to change an angle of the at least one object considering the pattern and control the display to display the object.

18. The device of claim 17, wherein, when two patterns are input, the processor is configured to control to change coordinates of the at least one object considering a first pattern, change the angle of the at least one object considering an angle between the first pattern and the second pattern, and control the display to display the object.

19. A non-transitory computer-readable storage medium encoded with computer-executable instructions that when executed cause a data processing system to perform the steps of:
displaying a plurality of objects;
detecting input of a touch pattern for changing a shape or location of at least one of the plurality of objects; and
changing the shape or location of the at least one object considering the pattern and displaying the object.

20. The computer-readable storage medium of claim 19, wherein the object comprises at least one of at least one letter which is input by writing, at least one letter which is input through a keypad, an icon, a picture, a photo, a figure, and a clip art.
